(19) United States
(12) Patent Application Publication
(10) Pub. No.: US 2024/0255300 A1
(43) Pub. Date: Aug. 1, 2024

(54) DRIVING INFORMATION DISPLAY DEVICE AND METHOD USING CONTROL OF SWITCHING TO AUGMENTED REALITY

(71) Applicants: HYUNDAI MOTOR COMPANY, Seoul (KR); KIA CORPORATION, Seoul (KR); Hyundai Autoever Corp, Seoul (KR)

(72) Inventors: Sung Taehyun, Hwaseong-si (KR); Kim Chihwan, Hwaseong-si (KR); DongChul Lee, Seoul (KR); TaeWoo Lee, Seoul (KR)

(73) Assignees: HYUNDAI MOTOR COMPANY, Seoul (KR); KIA CORPORATION, Seoul (KR); Hyundai Autoever Corp, Seoul (KR)

(21) Appl. No.: 18/543,486

(22) Filed: Dec. 18, 2023

(30) Foreign Application Priority Data
Jan. 30, 2023 (KR) 10-2023-0011364

(51) Int. Cl. G01C 21/36; G01C 21/34

(52) U.S. Cl. CPC G01C 21/3638; G01C 21/3492; G01C 21/3658; G01C 21/3694

(57) ABSTRACT

In a driving information display device and method, the driving information display device includes: a processor configured to receive driving guidance information, and to output map-based guidance information or augmented reality-based guidance information based on the driving guidance information; and a storage unit electrically and communicatively connected to the processor and configured to store road information and an algorithm. The processor is further configured to: receive the location information of a vehicle; identify a driving route of the vehicle and a guidance point; determine the augmented reality-based guidance information to be guidance information to be output when the distance from the location of the vehicle to the guidance point is equal to or shorter than a predetermined first reference distance; determine the map-based guidance information to be the guidance information to be output when the distance from the location of the vehicle to the guidance point exceeds the first reference distance; and generate a control command.

### CROSS-REFERENCE TO RELATED APPLICATION

The present application claims priority to Korean Patent Application No. 10-2023-0011364 filed on Jan. 30, 2023, the entire contents of which is incorporated herein for all purposes by this reference.

### BACKGROUND OF THE PRESENT DISCLOSURE

### Field of the Present Disclosure

The present disclosure relates to a driving information display device and method using the control of switching to augmented reality, and more particularly, to a device for providing effective guidance to a driver by displaying information for guidance on a driving route of a vehicle using augmented reality and a map, and a method of operating the device.

### Description of Related Art

With the development of location information and geographic information processing technology using the Global Positioning System (GPS) and/or the like, various types of driving information are provided in a process in which a vehicle drives. In particular, with the development of vehicle navigation systems and head-up displays (HUDs), methods for representing driving information are also diversifying.

In connection with this, there are increasing technologies for driving information guidance using augmented reality. However, in the case of driving route guidance using such augmented reality technology, it may be difficult to become aware of an overall driving route, and thus there is a need to be used in combination with guidance using a map.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing effective switching between augmented reality-based guidance information and map-based guidance information.

An object of the present disclosure is to enable effective guidance by selecting one of augmented reality-based guidance and map-based guidance depending on a driving route of a vehicle, the characteristics of a road, the location of a guidance point, and/or the like.

An object of the present disclosure is to prevent a driver from being confused by excessively frequent switching between augmented reality-based guidance and map-based guidance when situations in which guidance information needs to be output occur consecutively.

Various aspects of the present disclosure are directed to providing effective driving route guidance to a driver according to the locations of a guidance point and a lane guidance point.

The objects to be solved as an exemplary embodiment of the present disclosure are not limited to the objects described above, and other objects may be clearly understood by those skilled in the art from the following detailed description of the present disclosure.

According to various aspects of the present disclosure, there is provided a driving information display device including: a processor configured to receive driving guidance information, and to output map-based guidance information or augmented reality-based guidance information based on the driving guidance information; and a storage unit electrically and communicatively connected to the processor and configured to store road information and an algorithm executed by the processor; wherein the processor is further configured to: receive the location information of a vehicle; identify a driving route of the vehicle and a guidance point on the driving route based on the driving guidance information; determine the augmented reality-based guidance information to be guidance information to be output when a distance on the driving route from the location of the vehicle to the guidance point is equal to or shorter than a predetermined first reference distance; determine the map-based guidance information to be the guidance information to be output when the distance on the driving route from the location of the vehicle to the guidance point exceeds the first reference distance; and generate a control command to output the determined guidance information.

The processor may be further configured to: determine the map-based guidance information to be guidance information to be output when the vehicle has passed through the guidance point; and determine the augmented reality-based guidance information to be guidance information to be output when a distance on the driving route from the location of the vehicle to a subsequent guidance point after the passing of the vehicle through the guidance point is equal to or shorter than a predetermined second reference distance.

The second reference distance may be set to a distance which is longer than the first reference distance by a predetermined ratio.

The processor may be further configured to: receive the speed information of the vehicle; and determine the guidance information to be output by setting the first reference distance to a longer distance when the speed of the vehicle is equal to or greater than a predetermined reference value.

The processor may be further configured to: determine the type of road on which the vehicle is driving based on the driving guidance information and the location information of the vehicle; and set the first reference distance based on the identified type of road.

The processor may be further configured to: identify the level of road congestion on the driving route of the vehicle based on the driving guidance information and the location information of the vehicle; and set the first reference distance based on the identified level of the road congestion.

The processor may be further configured to, when a re-search for a route is performed while the augmented reality-based guidance information is being output, determine to output the augmented reality-based guidance information until a new guidance point is identified through the re-search for the route.

Information related to the guidance point may further include information related to a lane guidance point at which there is provided guidance on a lane along which the vehicle needs to drive before the guidance point; and the processor may be further configured to, when the distance between the guidance point and the lane guidance point is equal to or longer than a predetermined third reference distance, determine guidance information to be output using a location of the lane guidance point.

The third reference distance may be set to a distance which is longer than the first reference distance by a predetermined ratio; and the processor may be further configured to, when the distance between the guidance point and the lane guidance point is equal to or longer than the predetermined third reference distance, determine the augmented reality-based guidance information to be guidance information to be output when the vehicle has passed through the lane guidance point along the driving route and the distance between the vehicle and the lane guidance point is equal to or longer than the difference between the third reference distance and the first reference distance.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing the internal configuration of a driving information display device according to various exemplary embodiments of the present disclosure:

FIG. 2 is a diagram showing an example of screens for providing guidance on a driving route using a driving information display device according to various exemplary embodiments of the present disclosure:

FIG. 3 is a diagram showing locations at which guidance information is output in a driving information display device according to various exemplary embodiments of the present disclosure:

FIG. 4 is a diagram showing an exemplary embodiment in the case where consecutive guidance points are present in a driving information display device according to various exemplary embodiments of the present disclosure;

FIG. 5 is a diagram showing an exemplary embodiment in which points for the display of guidance information are differently implemented according to the type of road in a driving information display device according to various exemplary embodiments of the present disclosure;

FIG. 6 is a diagram showing an example of a case in which a re-search for a route is performed in a driving information display device according to various exemplary embodiments of the present disclosure:

FIG. 7 is a diagram showing an exemplary embodiment in which guidance information is displayed according to the locations of a guidance point and a lane guidance point in a driving information display device according to various exemplary embodiments of the present disclosure;

FIG. 8 is a diagram showing another exemplary embodiment in which guidance information is displayed according to the locations of a guidance point and a lane guidance point in a driving information display device according to various exemplary embodiments of the present disclosure;

FIG. 9 is a flowchart showing the flow of the process of determining guidance information to be output in a driving information display device according to various exemplary embodiments of the present disclosure; and

FIG. 10 is a flowchart showing the flow of a driving information display method according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Embodiments of the present disclosure will be described in detail below with reference to the accompanying drawings. In the following description of the present disclosure, when it is determined that a detailed description of any related known configuration or function may obscure the gist of the present disclosure, the detailed description will be omitted. Furthermore, in the following description of the exemplary embodiments of the present disclosure, specific numerical values are only examples, and the scope of the present disclosure is not limited thereby.

In the following descriptions of the components of the exemplary embodiments of the present disclosure, terms such as first, second, A, B, (a), (b), and so forth may be used. These terms are used merely to distinguish corresponding components from other components, and the natures, sequential positions, and/or orders of the corresponding components are not limited by the terms. Furthermore, unless defined otherwise, all the terms used herein, including technical or scientific terms, include the same meanings as commonly understood by those skilled in the art to which an exemplary embodiment of the present disclosure pertains. Terms such as those defined in commonly used dictionaries should be interpreted as having meanings consistent with the meanings in the context of related art, and should not be interpreted as having ideal or excessively formal meanings unless explicitly defined in the present application.

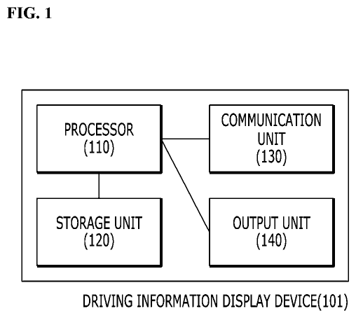

Embodiments of the present disclosure will be described in detail below with reference to FIGS. 1 to 10.

FIG. 1 is a block diagram showing the internal configuration of a driving information display device 101 according to various exemplary embodiments of the present disclosure.

The driving information display device 101 according to the exemplary embodiment may be provided inside a means of transportation such as a vehicle, or may be implemented in a detachable form. The driving information display device 101 may generally include the form of a vehicle navigation system, an audio, video and navigation (AVN) system, a head-up display (HUD), or the like, and may be implemented in a form in which an application is provided on a mobile phone terminal such as a smartphone.

The driving information display device 101 according to the exemplary embodiment may be present in a form of a server outside a means of transportation such as a vehicle. In the instant case, the driving information display device 101 may be implemented to generate driving guidance information by processing determinations while being present outside a means of transportation and to output the driving guidance information to a display present inside the means of transportation. Furthermore, various embodiments may be implemented. The scope of rights of the present disclosure is not limited by the forms of such implementations.

Furthermore, the driving information display device 101 of the exemplary embodiment may operate in conjunction with devices for autonomous driving control such as an advanced driver assistance system (ADAS), a smart cruise control (SCC) system, a forward collision warning (FCW) system, and/or the like.

As shown in the drawing, the driving information display device 101 according to the exemplary embodiment may include a processor 110, a storage unit 120, a communication unit 130, and an output unit 140.

The processor 110 is configured to control the storage unit 120, the communication unit 130, and the output unit 140 to execute an application, process data according to the algorithm defined in the application, communicate with an external module, and provide the results of the processing to a user.

The processor 110 may refer to a chip for processing a general algorithm, such as a central processing unit (CPU) or an application processor (AP), or a set of such chips. The processor 110 may refer to a chip optimized for floating-point arithmetic, such as a general-purpose computing on graphics processing unit (GPGPU), to process an artificial intelligence algorithm such as deep learning, or a set of such chips. Alternatively, the processor 110 may refer to a module in which various types of chips perform an algorithm and process data in a connected and distributed manner.

The processor 110 may be electrically connected to the storage unit 120 and the communication unit 130, may electrically control the individual components, may be an electric circuit that executes software commands, and may perform various types of data processing and determination to be described later. The processor 110 may be, for example, an electronic control unit (ECU), a micro-controller unit (MCU), or another lower level controller which is mounted on a means of transportation.

The storage unit 120 stores road information and an algorithm executed by the processor. The road information may include map information, road traffic condition information, and/or the like. Depending on the configuration of the driving information display device 101 of the present disclosure, the form or amount of road information stored inside the driving information display device 101 may vary.

In some cases, the storage unit 120 may store road information including the map information and traffic condition information of all serviceable areas and provide services based on the road information. Alternatively, the storage unit 120 may temporarily store only road information related to a location where guidance is being made and provide services based on the temporarily stored road information.

This may be implemented as a different form depending on the form in which the driving information display device 101 according to an exemplary embodiment of the present disclosure is implemented inside or outside a means of transportation, the communication method used, the storage space of the storage unit 120, and/or input/output speed. This is a part which may be chosen autonomously by those skilled in the art depending on the implementation situation. The scope of rights of the present disclosure is not limited by such changes in implementations.

The storage unit 120 may store graphic information that will be added to an image obtained by capturing a situation in front of a vehicle or a scene seen through a windshield by use of augmented reality technology. The graphic information may include images to be output according to various types of guidance.

The storage unit 120 may have various forms, and may be at least one type of storage medium such as a flash memory-, hard disk-, micro-, card (e.g., secure digital (SD) card)-, extreme digital (XD) card-, random access memory (RAM)-, static RAM (SRAM)-, read-only memory (ROM)-, programmable ROM (PROM)-, electrically erasable PROM (EPROM)-, magnetic memory (MRAM)-, magnetic disk-, or optical disk-type storage medium, or the like. Depending on the amount, processing speed, storage time, and/or the like of data to be stored, a different type of storage medium or a combination of different types of storage media may be chosen.

The algorithm stored in the storage unit 120 may be implemented as a computer program in an executable form, and may be implemented to be stored in the storage unit 120 and then executed in a required situation. The algorithm stored in the storage unit 120 may be interpreted as including an instruction form which is temporarily loaded into volatile memory and instructs the processor to perform specific operations.

The communication unit 130 receives information for driving guidance from the outside of the driving information display device 101 of the present disclosure over a wired/wireless communication network, and transmits necessary information to an external module.

The communication unit 130 may receive road information stored in the storage unit 120, an algorithm executed by the processor 110, and the like from an external module, and may transmit information related to the current state of a means of transportation to the outside to obtain necessary information related to the transmitted information. For example, the communication unit 130 may continuously receive traffic information from a traffic information server to check real-time traffic information, and is configured to transmit the location and route information of a means of transportation, found through a module such as a Global Positioning System (GPS) receiver, to the outside to obtain the real-time traffic information of an area related to the location and route of the means of transportation.

The communication unit 130 is a hardware device which is implemented using various electronic circuits to transmit and receive signals over a wireless or wired connection. In an exemplary embodiment of the present disclosure, the communication unit 130 may perform communication within a means of transportation using infra-transportation means network communication technology, and may perform Vehicle-to-Infrastructure (V2I) communication with a server, infrastructure, another means of transportation, and/or the like outside a means of transportation using wireless Internet access or short-range communication technology. In the instant case, the communication within a means of transportation may be performed using Controller Area Network (CAN) communication, Local Interconnect Network (LIN) communication, FlexRay communication, and/or the like as the infra-transportation means network communication technology. Furthermore, such wireless communication technology may include wireless LAN (WLAN), Wireless Broadband (WiBro), Wi-Fi, Worldwide Interoperability for Microwave Access (WiMAX), etc. Moreover, the short-range communication technology may include Bluetooth, ZigBee, Ultra-wideband (UWB), Radio Frequency Identification (RFID), Infrared Data Association (IrDA), etc.

The output unit 140 may output augmented reality information which is controlled by executing the algorithm, stored in the storage unit 120, by the processor 110. Augmented reality is a technology for enabling related information to be provided by adding graphic information to an image or scene of the real world.

The output unit 140 may be implemented as a head-up display (HUD), a cluster, an audio, video and navigation (AVN) system, a human-machine interface (HMI), and/or the like. Furthermore, the output unit 140 may include at least one of a liquid crystal display (LCD), a thin film transistor liquid crystal display (TFT LCD), a light emitting diode (LED) display, an organic light emitting diode (OLED) display, an active matrix OLED (AMOLED) display, a flexible display, a bended display, and a three-dimensional (3D) display. Some of these displays may be implemented as a transparent display configured in a transparent or translucent form to be able to view the outside thereof. Furthermore, the output unit 140 may be provided as a touch screen including a touch panel, and may be used as an input device as well as an output device.

When the output unit 140 is implemented in a form of a general opaque display, the processor 110 may play back, in real time, an image obtained by capturing a situation in front of a means of transportation such as a vehicle on the output unit, may check the image being played back for a location where information will be displayed, and may add graphic information for the representation of augmented reality information to the present location, providing a user with related information in a realistic manner. In the instant case, the graphic information may be information indicating a direction in which a vehicle needs to drive in a turning section, and is also referred to as a dynamic wall.

Furthermore, when the output unit 140 is implemented in a form of a transparent display, the front screen of a means of transportation, such as a vehicle, seen through a transparent screen may be checked for a location where information will be displayed, graphic information for the representation of augmented reality information may be added to the present location, and then resulting information may be output. The present disclosure is applicable to both types of displays, and the type of processing of the processor 110 may vary depending on the type of output unit 140. Such changes in design fall within a sufficiently feasible range for those skilled in the art, and the scope of rights of the present disclosure is not limited by such changes in design.

The driving information display device 101 according to an exemplary embodiment of the present disclosure may be used in different forms according to the manner in which the processor 110 processes augmented reality. Accordingly, the functions of the processor 110 will be described below in examples based on various situations. In the instant case, the vehicle may be described as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

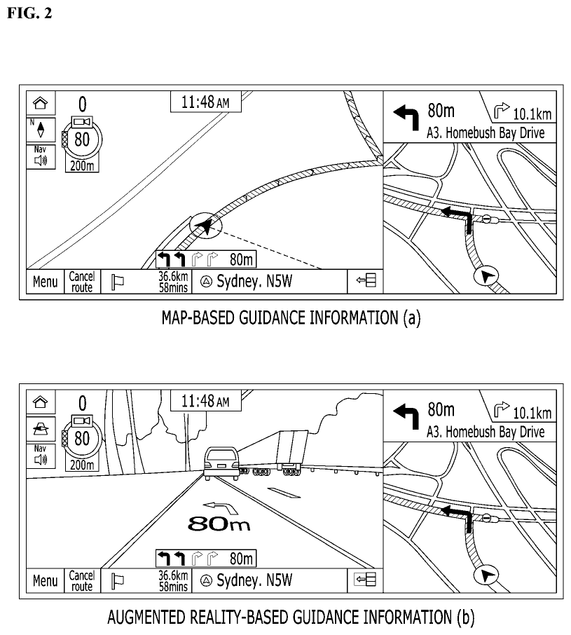

FIG. 2 is a diagram showing an example of screens for providing guidance on a driving route using a driving information display device according to various exemplary embodiments of the present disclosure.

As shown in the drawing, the driving information display device 101 according to the exemplary embodiment of the present disclosure receives driving guidance information including information related to a driving route along which a vehicle needs to drive, receives the current location information of the vehicle, and outputs guidance information related to how the vehicle drives according to the driving route along which the vehicle needs to drive.

The output guidance information may be classified into two types. The first type of information is map-based guidance information (a). Map-based guidance is performed by displaying a driving route and the current location of a vehicle on a map of an area around the vehicle while outputting the map in a two-dimensional (2D) or 3D form and also outputting information related to how the vehicle needs to drive at an intersection, as shown in the drawing. In general, the present method is a method mainly used in vehicle guidance devices such as existing vehicle navigation systems. The present method includes the advantage of being able to check a situation around a vehicle more widely and also allowing a driver to become aware of a wide range of driving route in advance. In contrast, the present method includes a disadvantage in that a driver may have difficulty in making a decision by matching an actual road against a map at a complex intersection or the like.

The second type of information is augmented reality-based guidance information (b). Augmented reality-based guidance may be performed by outputting an image of a situation in front of a vehicle on a display screen and also adding graphic information to the image of the situation in front of the vehicle, guiding a user through a route along which the vehicle needs to drive. Furthermore, when a head-up display or the like is used, it may also be possible to add graphic information to a scene seen through the windshield of a vehicle and output resulting information.

In the case of outputting augmented reality-based guidance information in the present manner, there is an advantage in that a driver can more easily check a route along which a vehicle needs to drive in front of their eyes because accurate guidance may be provided based on an actual scene seen in front of the vehicle in situations such as a complex intersection situation. In contrast, in the case of guidance based on augmented reality, only guidance on a scene in front of the eyes of a driver may be provided, so that the driver may suffer from difficulty in determining an overall driving route and also determining the driving situations of a vehicle over a wide range.

Because each of the map-based guidance information (a) and the augmented reality-based guidance information (b) has advantages and disadvantages, it is necessary to effectively switch between the two types of information depending on the situation and then output resulting information.

Accordingly, the driving information display device 101 of the present disclosure receives driving guidance information from the processor 110, is configured to determine the type of guidance information which is currently effective for provision to a driver through the driving guidance information, and is configured to perform control so that any one of map-based guidance information and augmented reality-based guidance information is selected and output, enabling effective guidance to be provided to the driver according to the situation.

The processor 110 receives driving guidance information and the location information of a vehicle, identifies a driving route of the vehicle and a guidance point on the driving route based on the driving guidance information, and is configured to determine the augmented reality-based guidance information to be guidance information to be output when the distance from the location of the vehicle to the guidance point is equal to or shorter than a predetermined first reference distance and is configured to determine the map-based guidance information to be the guidance information to be output when the distance from the location of the vehicle to the guidance point exceeds the predetermined first reference distance.

In the instant case, the guidance point refers to a point that requires specific guidance on a route along which a vehicle needs to drive, such as an intersection. As described above, at locations requiring specific guidance, augmented reality-based guidance information may provide more effective guidance than map-based guidance information. Accordingly, when a vehicle enters a location within a predetermined first reference distance from a guidance point and approaches the guidance point, augmented reality-based guidance information is output. When there is no close guidance point in front of a vehicle and thus an overall route needs to be shown, map-based guidance information is output.

When the type of guidance information to be output is determined, the processor 110 may be configured to generate a control command to output the determined guidance information, and may allow the guidance information, generated according to the control command, to be output via the output unit 140.

How the driving information display device 101 operates based on the processor 110 according to various situations in which guidance information is displayed will be described below with reference to diagrams for respective situations.

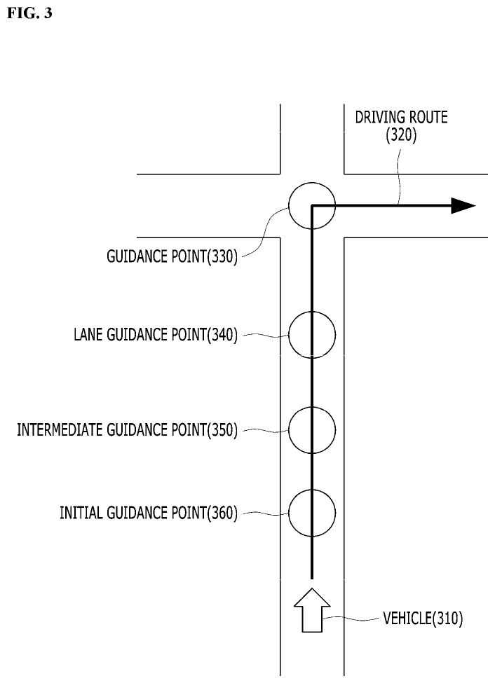

FIG. 3 is a diagram showing locations at which guidance information is output in a driving information display device according to various exemplary embodiments of the present disclosure.

When a vehicle 310 is driving along a driving route 320 after the selection of a destination at which a driver needs to arrive and when a guidance point 330 requiring guidance on a driving direction, such as an intersection, appears in front of the vehicle 310, guidance information for this may be provided several times.

First, when the vehicle 310 arrives at an initial guidance point 360, which is the point farthest from the guidance point 330, information related to the presence of the guidance point 330 in the front of the vehicle 310 and the direction in which the vehicle 310 needs to drive at the guidance point 330 is provided as guidance information. Thereafter, when the vehicle 310 arrives at an intermediate guidance point 350, the same type of guidance is provided. When guidance on a driving lane is required, guidance information related to the lane along which the vehicle 310 needs to drive at the lane guidance point 340 is output. Thereafter, when the vehicle 310 arrives at a location close to the guidance point 330, specific guidance is made on the direction in which the vehicle 310 needs to drive in front of the vehicle 310.

The driving information display device 101 according to the exemplary embodiment outputs map-based guidance information to enable a drive to become aware of an overall driving route in a situation in which the vehicle 310 is driving through points where separate guidance is not required, and displays information related to the forward guidance point 330 on the map-based guidance information at the initial guidance point 360, the intermediate guidance point 350, and the lane guidance point 340.

Thereafter, when the vehicle 310 arrives at a location within a first reference distance from the guidance point 330, the guidance information is switched to augmented reality-based guidance information, so that graphic information for guiding the driver through the driving route is added to an image of a situation in front of the vehicle or an actual scene seen through an windshield and then resulting information is output by use of augmented reality technology, enabling the driver to intuitively become aware of a driving route along which he or she needs to drive the vehicle.

When the vehicle has passed through the guidance point 330 and the guidance ends, the processor 110 is configured to perform control so that map-based guidance information may be output via the output unit 140 by selecting the map-based guidance information as guidance information to be output.

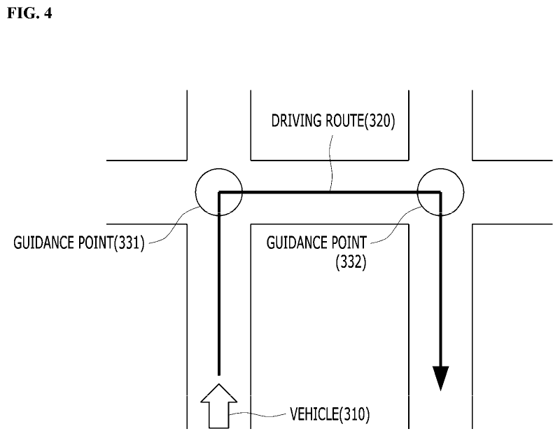

FIG. 4 is a diagram showing an exemplary embodiment in the case where consecutive guidance points are present in a driving information display device according to various exemplary embodiments of the present disclosure.

In the instant case, as shown in the drawing, there may be a case where a first guidance point 331 and a second guidance point 332 are consecutively present in front of a vehicle 310.

In the instant case, when the vehicle 310 enters a location away from the first guidance point 331 by a first reference distance, the processor 110 switches a screen by performing control so that augmented reality-based guidance information may be output. Thereafter, after the vehicle 310 has passed through the first guidance point 331, the processor 110 is configured to perform control so that map-based guidance information may be output. Thereafter, when the vehicle 310 enters a location within the first reference distance from the second guidance point 332 again, control is performed so that augmented reality-based guidance information may be output again.

When the distance between the first guidance point 331 and the second guidance point 332 is sufficiently long, such guidance may be effective.

Furthermore, when the distance between the first guidance point 331 and the second guidance point 332 is very close within the first reference distance, augmented reality-based guidance information is continuously output, so that continuous guidance information may be effectively provided to a driver using augmented reality.

However, when the distance between the first guidance point 331 and the second guidance point 332 is farther than the first reference distance but they are considerably close to each other, frequent switching between map-based guidance information and augmented reality-based guidance information occurs within a short time period, which may confuse the driver.

For example, in the case where the first reference distance is 100 m and the distance between the first guidance point 331 and the second guidance point 332 is 130 m, map-based guidance information is output in response to the driving of the vehicle 310, and then the guidance information is switched to augmented reality-based guidance information when the vehicle 310 enters a location within 100 m from the first guidance point 331. After the vehicle 310 has passed through the first guidance point 331, the guidance information is switched back to map-based guidance information. When the vehicle drives 30 m further and thus enters a location within the first reference distance (100 m) from the second guidance point 332, augmented reality-based guidance information is output again. Thereafter, after the vehicle 310 has passed through the second guidance point 332, map-based guidance information is output. Therefore, switching between map-based guidance information and augmented reality-based guidance information occurs frequently within a short time period, which may rather cause confusion to the driver.

Accordingly, the processor 110 is configured to determine the augmented reality-based guidance information to be guidance information to be output when the distance on a driving route from the location of the vehicle 310 to the subsequent guidance point 332 after the passing of the vehicle 310 through the guidance point 331 is equal to or shorter than a second reference distance. In the instant case, the second reference distance may be set to a distance which is longer than the first reference distance by a predetermined ratio.

When the predetermined ratio is 150%, augmented reality-based guidance information starts to be output at a location 100 m away from the first guidance point 331 in response to the driving of the vehicle 310 in the above example. After the vehicle 310 has passed through the first guidance point 331, it is checked whether the vehicle 310 is within the second reference distance of 150 m (150% of 100 m) from the second guidance point 332. In the instant case, the distance between the first guidance point 331 and the second guidance point 332 is 130 m and is thus shorter than the second reference distance of 150 m, the guidance information is not switched to map-based guidance information, and augmented reality-based guidance information is continuously output.

The processor 110 may variably set the first reference distance and the second reference distance according to the location of the vehicle, driving conditions, the type of road, road traffic conditions, and/or the like.

When a vehicle drives at high speed, it is necessary to set the first reference distance and the second reference distance to longer distances because the vehicle can drive a longer distance in a shorter time. In contrast, when the vehicle drives at low speed, it is necessary to set the first reference distance and the second reference distance to shorter distances.

For example, when a vehicle drives at 50 km/h, it takes about 7 seconds to drive 100 m. In contrast, when the vehicle drives at 100 km/h, it takes about 3.6 seconds to drive 100 m. If the same reference distances are set for both situations, the driver feels differently about the switching frequency of guidance information.

Accordingly, the processor 110 may be configured to determine guidance information to be output by receiving vehicle speed information and then setting the first reference distance to a longer distance when the vehicle speed is equal to or greater than a predetermined reference value. For example, when the reference vehicle speed value is set to 100 km/h and the vehicle speed exceeds 100 km/h, the first reference distance may be set to 150% of an originally set distance. In the instant case, the second reference distance is longer than the first reference distance by a predetermined ratio as described above, so that it may be set to a much longer distance.

The reference speed value used for changing the reference distances according to the speed of the vehicle may be set for one speed as in the above example. In some cases, an implementation may be made so that different first reference distances are set based on a plurality of reference values. In the instant case, the first reference distance and the second reference distance may be set differently according to the speed section, so that appropriate guidance suitable for a situation may be provided.

Furthermore, the processor 110 may be configured to determine the type of road on which the vehicle is driving based on the driving guidance information and the location information of the vehicle, and may set the first reference distance according to the identified type of road.

The types of roads may be classified into expressways, urban expressways, and general roads, and may be further subdivided and set according to the speed limit and degree of curvature of the road. Because the average speed at which a vehicle drives varies depending on the type of road, the first reference distance is set to a long distance for a road along which a vehicle can drive at high speed. For a road along which a vehicle needs to drive at low speed, the first reference distance is set to a short distance.

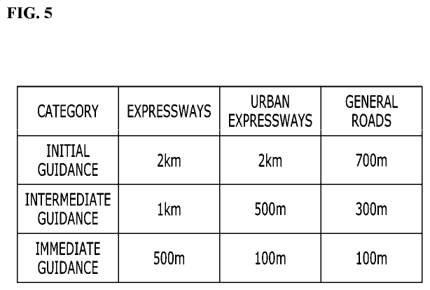

FIG. 5 is a diagram showing an exemplary embodiment in which points for the display of guidance information are differently implemented according to the type of road in a driving information display device according to various exemplary embodiments of the present disclosure.

In the drawing, when the types of roads include three types: expressways, urban expressways, and general roads, locations for initial guidance, intermediate guidance, and immediate guidance are set for each type of roads. In the instant case, the distance to a point at which immediate guidance is provided may be set as the first reference distance.

Therefore, the processor 110 may perform control so that augmented reality-based guidance information starts to be output at a point 500 m away from a guidance point when a vehicle is driving on a highway, and may perform control so that augmented reality-based guidance information starts to be output at a point 100 m away from a guidance point on an urban highway or a general road.

The type of road on which a vehicle is currently driving may be identified based on the location information of the vehicle and driving guidance information. Each road may be classified according to a classification standard and stored together with map information, and the type of road may be identified from the stored map information by checking a current road based on the location of a vehicle.

Information related to reference distances according to the type of road such as those shown in the drawing may be stored in the storage unit 120, and may be referred to by the processor 110. An implementation may be made so that reference distances according to the type of road may be changed according to a driver's settings.

Furthermore, the processor 110 may be configured to determine the level of road congestion on a driving route of a vehicle based on driving guidance information and the location information of the vehicle, and may set the first reference distance based on the determined level of road congestion. Even in the case where a vehicle is driving on an expressway or is currently driving fast, when congestion occurs near a guidance point, it may be necessary to set the reference distance to a shorter distance.

The level of road congestion may be received from an external traffic information server via the communication unit 130, a speed at which a vehicle can drive on a driving route along which the vehicle needs to drive may be predicted, and a reference distance may be set based on the prediction.

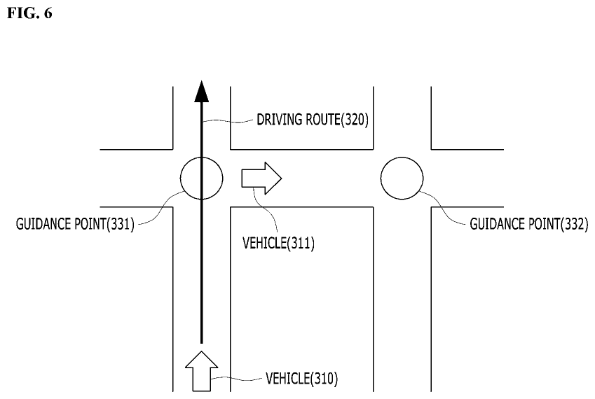

FIG. 6 is a diagram showing an example of a case in which a re-search for a route is performed in a driving information display device according to various exemplary embodiments of the present disclosure.

When a vehicle 310 deviates from a guidance driving route 320 without driving along the guidance driving route 320, a re-search is performed. In the drawing, when the vehicle 311 having passed through a guidance point 331 drives along a route different from the guidance driving route 320, a new driving route is found through a re-search.

In the instant case, because the vehicle 331 has passed through the guidance point 331, the processor 110 may be configured to determine to output map-based guidance information. While a re-search is being performed, it may be impossible to identify a subsequent guidance point 332. Accordingly, in the instant case, it may be possible to, while continuing to output augmented reality-based guidance information, identify the guidance point 332, check a corresponding criterion when the guidance point 332 is identified, and determine guidance information to be output again.

In other words, when a re-search for a route is performed while augmented reality-based guidance information is being output, the processor 110 is configured to determine to continue to output the augmented reality-based guidance information until a new guidance point is identified through the re-search for the route.

When the new guidance point is identified, it is checked whether the distance to the identified guidance point is shorter than the second reference distance, and it is determined based on the results of the determination whether augmented reality-based guidance information is continuously output. Through this, the inconvenience caused to a driver due to repetitive screen switching may be minimized in a process of performing a re-search for a route.

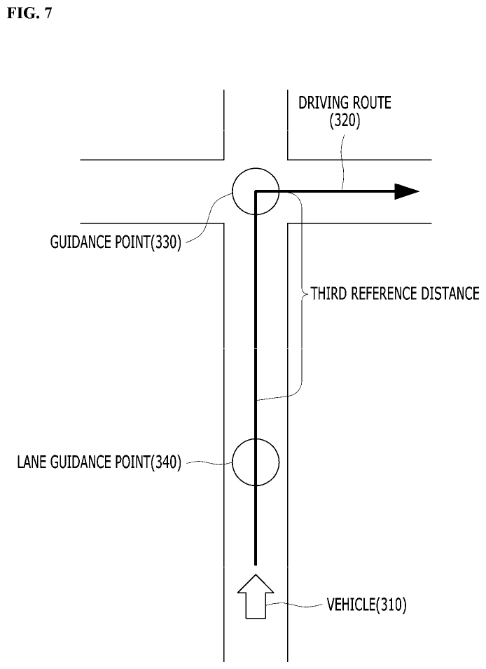

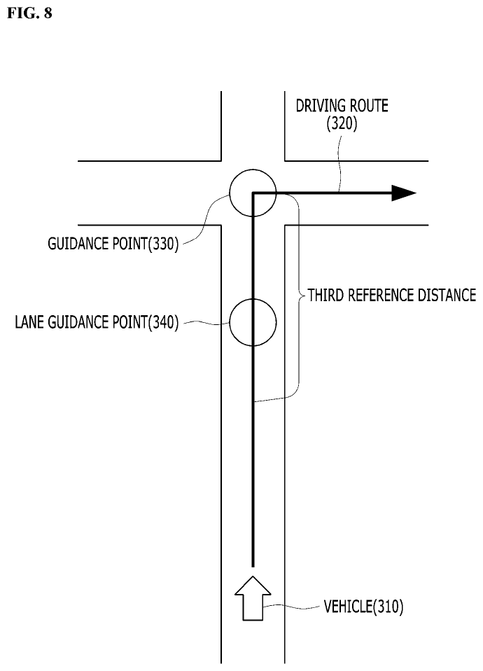

FIG. 7 and FIG. 8 are diagrams showing two embodiments in which guidance information is displayed according to the locations of a guidance point and a lane guidance point in a driving information display device according to various exemplary embodiments of the present disclosure.

As described above, when it is necessary to provide guidance on a lane before a guidance point 330, a lane guidance point 340 may be present. The lane guidance point 340 may be a location where there is a mark for providing guidance on a lane on the floor of a road, and previously identified information may be stored together with map information stored in the storage unit 120.

When guidance on a lane is provided at the lane guidance point 340, providing map-based guidance information may be more accurate than providing augmented reality-based guidance information. To provide guidance on a lane through augmented reality-based guidance information, per-lane based accurate recognition is required and an overall lane on which guidance will be provided needs to be included in an image of a situation in front of a vehicle, so that providing guidance on a lane through map-based guidance information may be more effective.

Furthermore, when the distance between the lane guidance point 340 and the guidance point 330 is long, it takes time to arrive at the guidance point 330 after lane guidance, which may cause confusion for a driver. Accordingly, it is desirable to continue to provide guidance on the lane through augmented reality-based guidance information so that the vehicle can drive along the guidance lane.

Therefore, when the lane guidance point 340 is present before the guidance point 330 on the driving route 320 of the vehicle 310, the processor 110 is configured to determine the distance between the guidance point 330 and the lane guidance point 340, and is configured to determine guidance information to be output using the location of the lane guidance point 340 when the determined distance is equal to or longer than a predetermined third reference distance.

In the instant case, the third reference distance may be set to a distance which is longer than the first reference distance by a predetermined ratio. In the case where the distance between the guidance point and the lane guidance point is equal to or longer than the predetermined third reference distance, the processor 110 is configured to determine the augmented reality-based guidance information to be guidance information to be output when the vehicle has passed through the lane guidance point along the driving route and the distance between the vehicle and the lane guidance point is equal to or longer than the difference between the third reference distance and the first reference distance.

For example, when the first reference distance is 100 m and the third reference distance is set to 130 m, which is 130% of the first reference distance, the distance between the guidance point 330 and the lane guidance point 340 is 130 m or longer in FIG. 7. Accordingly, after the vehicle 310 has passed through the lane guidance point 340 and has driven 30 m, which is the difference between the third reference distance and the first reference distance, the processor 110 provides detailed lane guidance by outputting augmented reality-based guidance information regardless of the distance to the guidance point 330.

In contrast, in the case where the distance between the lane guidance point 340 and the guidance point 330 is equal to or shorter than the third reference distance of 130 m as shown in FIG. 8, the screen is switched to output augmented reality-based guidance information when the vehicle enters a location within 100 m, which is the first reference distance, from the guidance point 330 according to the existing standard.

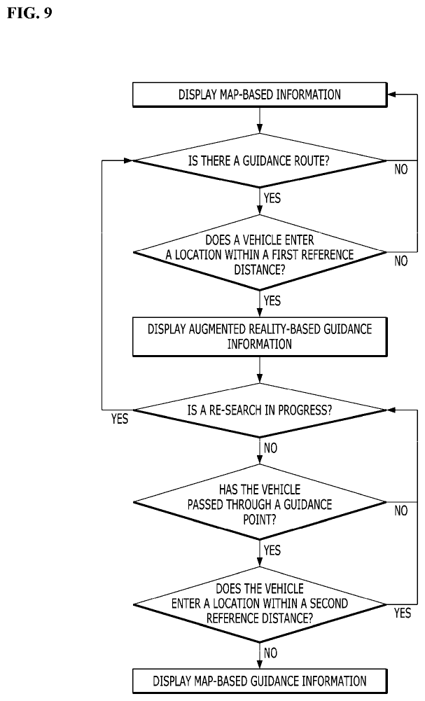

FIG. 9 is a flowchart showing the flow of the process of determining guidance information to be output in a driving information display device according to various exemplary embodiments of the present disclosure.

First, when the driving of a vehicle starts, map-based information is displayed so that a map of the surroundings of the vehicle and information related to the current location of the vehicle are output.

When a driver sets a destination, a guidance route is generated. The processor 110 checks whether the guidance route is present, and allows map-based information to be continuously output as in the beginning when there is not the guidance route and allows more effective information to be selected from augmented reality-based guidance information and map-based guidance information and output through the following logic when there is the guidance route.

The processor 110 is configured to determine whether the vehicle has entered a location within a first reference distance from a guidance point. To the present end, the location information of the vehicle, driving guidance information, and/or the like may be utilized, and the first reference distance may be determined differently depending on the speed of the vehicle, the type of road, the level of congestion, and/or the like as described above.

When the vehicle does not enter a location within the first reference distance from the guidance point, map-based guidance information is continuously output. In contrast, when the vehicle enters a location within the first reference distance, control is performed so that augmented reality-based guidance information is displayed.

Thereafter, the processor 110 checks whether a re-search is being performed, outputs augmented reality-based guidance information in the case of a re-search, and repeats the above process according to a new guidance route when the new guidance route is determined.

When guidance continues to be provided without a re-search, it is checked whether the vehicle has passed through the guidance point, and it is continuously checked whether the vehicle has passed through the guidance point when it is determined that the vehicle has not passed through the guidance point. When it is determined that the vehicle has passed through the guidance point, it is checked whether the distance to a subsequent guidance point is equal to or shorter than a second reference distance, and map-based guidance information is displayed only when the distance to the subsequent guidance point is longer than the second reference distance.

Through the above-described logic, guidance information may be effectively provided to a driver in two modes.

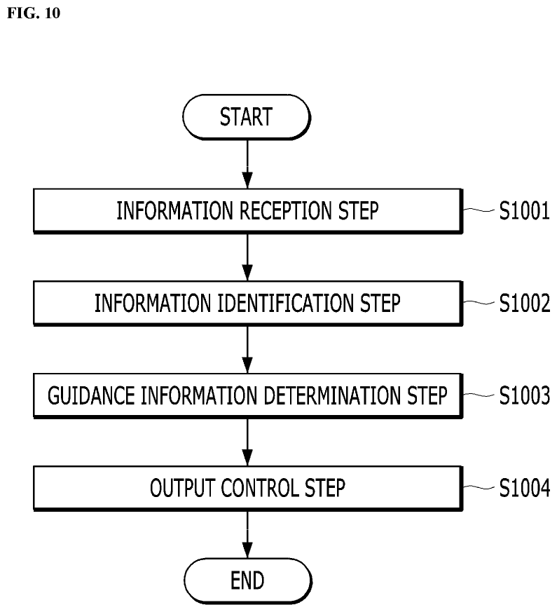

FIG. 10 is a flowchart showing the flow of a driving information display method according to various exemplary embodiments of the present disclosure.

As described above, the driving information display method of the present disclosure is performed in the driving information display device 101 including the processor and the storage unit, and all technical descriptions of the driving information display device 101 may be applied to the driving information display method of the present disclosure. Accordingly, even when detailed descriptions are not provided below; the technical components described in conjunction with the driving information display device 101 may be applied and used to implement the driving information display method. Conversely, it may also be possible to utilize the items described only in conjunction with the driving information display method to implement the driving information display device.

In an information reception step S1001, driving guidance information and the location information of a vehicle are received. The driving guidance information may include geographical information such as a driving route along which the vehicle needs to drive and a road on which the vehicle is driving. The location information of the vehicle may be obtained through one or more of various location sensors such as a Global Positioning System (GPS) receiver.

In an information identification step S1002, a driving route of the vehicle and a guidance point on the driving route are identified based on the driving guidance information.

In a guidance information determination step S1003, augmented reality-based guidance information is determined to be guidance information to be output when the distance on the driving route from the location of the vehicle to the guidance point is equal to or shorter than a predetermined first reference distance, and map-based guidance information is determined to be guidance information to be output when the distance on the driving route from the location of the vehicle to the guidance point exceeds the first reference distance.

In the instant case, in the guidance information determination step S1003, the map-based guidance information may be determined to be guidance information to be output when the vehicle has passed a guidance point, and the augmented reality-based guidance information may be determined to be guidance information to be output when the distance on the driving route from the location of the vehicle to a subsequent guidance point after the passing of the vehicle through the guidance point is equal to or shorter than a predetermined second reference distance. In the instant case, the second reference distance may be set a distance which is longer than the first reference distance by a predetermined ratio.

Furthermore, in the information reception step S1001, the speed information of the vehicle may further be received. In the guidance information determination step S1003, guidance information to be output may be determined by setting the first reference distance to a longer distance when the speed of the vehicle is equal to or greater than a predetermined reference value.

Moreover, in the information identification step S1002, the type of road on which the vehicle is driving is identified based on the driving guidance information and the location information of the vehicle. In the guidance information determination step S1003, the first reference distance may be set according to the identified type of road.

In the information identification step S1002, the level of road congestion on the driving route of the vehicle is identified based on the driving guidance information and the location information of the vehicle. In the guidance information determination step S1003, the first reference distance may be set based on the identified level of the road congestion.

Furthermore, in the guidance information determination step S1002, when a re-search for a route is performed while the augmented reality-based guidance information is being output, it may be determined that the augmented reality-based guidance information will be output until a new guidance point is identified through the re-search for the route.

In the instant case, the guidance point information further includes lane guidance point information, which is information related to a location where guidance on a lane along which the vehicle needs to drive before the guidance point is provided. In the guidance information determination step S1003, when the distance between the guidance point and the lane guidance point is equal to or longer than a predetermined third reference distance, guidance information to be output may be determined using the location of the lane guidance point.

In the instant case, the third reference distance may be set to a distance which is longer than the first reference distance by a predetermined ratio. In the guidance information determination step S1003, in the case where the distance between the guidance point and the lane guidance point is equal to or longer than the predetermined third reference distance, the augmented reality-based guidance information may be determined to be guidance information to be output when the vehicle has passed through the lane guidance point along the driving route and the distance between the vehicle and the lane guidance point is equal to or longer than the difference between the third reference distance and the first reference distance.

In an output control step S1004, a control command to output the determined guidance information is generated.

The present disclosure may achieve the advantage of effectively switching between augmented reality-based guidance information and map-based guidance information.

The present disclosure may achieve the advantage of enabling effective guidance by selecting one of augmented reality-based guidance and map-based guidance depending on a driving route of a vehicle, the characteristics of a road, the location of a guidance point, and/or the like.

The present disclosure may achieve the advantage of preventing a driver from being confused by excessively frequent switching between augmented reality-based guidance and map-based guidance when situations in which guidance information needs to be output occur consecutively.

The present disclosure may achieve the advantage of providing effective driving route guidance to a driver according to the locations of a guidance point and a lane guidance point.

Furthermore, various advantages which may be directly or indirectly understood by those skilled in the art may be provided throughout the present specification.

Although the present disclosure has been described with reference to the embodiments, those skilled in the art may variously modify and change the present disclosure without departing from the spirit and scope of the present disclosure described in the attached claims.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A driving information display device comprising:
a processor configured to:
receive driving guidance information; and
output map-based guidance information or augmented reality-based guidance information based on the driving guidance information; and
a storage unit electrically and communicatively connected to the processor and configured to store road information and an algorithm executed by the processor;
wherein the processor is further configured to:
receive location information of a vehicle;
identify a driving route of the vehicle and a guidance point on the driving route based on the driving guidance information;
determine the augmented reality-based guidance information to be the guidance information to be output in response that a distance on the driving route from a location of the vehicle to the guidance point is equal to or shorter than a predetermined first reference distance;
determine the map-based guidance information to be the guidance information to be output in response that the distance on the driving route from the location of the vehicle to the guidance point exceeds the first reference distance; and
generate a control command to output the determined guidance information.

2. The driving information display apparatus of claim 1, wherein the processor is further configured to:
determine the map-based guidance information to be the guidance information to be output in response that the vehicle has passed through the guidance point; and
determine the augmented reality-based guidance information to be the guidance information to be output in response that a distance on the driving route from the location of the vehicle to a subsequent guidance point after the passing of the vehicle through the guidance point is equal to or shorter than a predetermined second reference distance.

3. The driving information display apparatus of claim 2, wherein the second reference distance is set to a distance which is longer than the first reference distance by a predetermined ratio.

4. The driving information display apparatus of claim 1, wherein the processor is further configured to:
receive speed information of the vehicle; and
determine the guidance information to be output by setting the first reference distance to a longer distance in response that a speed of the vehicle is equal to or greater than a predetermined reference value.

5. The driving information display apparatus of claim 1, wherein the processor is further configured to:
determine a type of road on which the vehicle is driving based on the driving guidance information and the location information of the vehicle; and
set the first reference distance based on the identified type of road.

6. The driving information display apparatus of claim 1, wherein the processor is further configured to:
identify a level of road congestion on the driving route of the vehicle based on the driving guidance information and the location information of the vehicle; and
set the first reference distance based on the identified level of the road congestion.

7. The driving information display apparatus of claim 1, wherein the processor is further configured to:
in response that a re-search for a route is performed while the augmented reality-based guidance information is being output,
determine to output the augmented reality-based guidance information until a new guidance point is identified through the re-search for the route.

8. The driving information display apparatus of claim 1,
wherein information related to the guidance point further includes information related to a lane guidance point at which there is provided guidance on a lane along which the vehicle needs to drive before the guidance point, and
wherein the processor is further configured to:
in response that a distance between the guidance point and the lane guidance point is equal to or longer than a predetermined third reference distance,
determine the guidance information to be output using a location of the lane guidance point.

9. The driving information display apparatus of claim 8,
wherein the third reference distance is set to a distance which is longer than the first reference distance by a predetermined ratio, and
wherein the processor is further configured to:
in response that a distance between the guidance point and the lane guidance point is equal to or longer than the predetermined third reference distance,
determine the augmented reality-based guidance information to be the guidance information to be output in response that the vehicle has passed through the lane guidance point along the driving route and a distance between the vehicle and the lane guidance point is equal to or longer than a difference between the third reference distance and the first reference distance.

10. A driving information display method performed by a driving information display device including a processor and a storage unit, the driving information display method comprising:
an information reception step of receiving driving guidance information and location information of a vehicle;
an information identification step of identifying a driving route of the vehicle and a guidance point on the driving route based on the driving guidance information;
a guidance information determination step of determining augmented reality-based guidance information to be guidance information to be output in response that a distance on the driving route from a location of the vehicle to the guidance point is equal to or shorter than a predetermined first reference distance, and determining map-based guidance information to be the guidance information to be output in response that the distance on the driving route from the location of the vehicle to the guidance point exceeds the first reference distance; and
an input control step of generating a control command to output the determined guidance information.

11. The driving information display method of claim 10, wherein the guidance information determination step includes:
determining the map-based guidance information to be the guidance information to be output in response that the vehicle has passed through the guidance point; and
determining the augmented reality-based guidance information to be the guidance information to be output in response that a distance on the driving route from the location of the vehicle to a subsequent guidance point after the passing of the vehicle through the guidance point is equal to or shorter than a predetermined second reference distance.

12. The driving information display method of claim 11, wherein the second reference distance is set to a distance which is longer than the first reference distance by a predetermined ratio.

13. The driving information display method of claim 10,
wherein the information reception step includes receiving speed information of the vehicle, and
wherein the guidance information determination step includes determining the guidance information to be output by setting the first reference distance to a longer distance in response that a speed of the vehicle is equal to or greater than a predetermined reference value.

14. The driving information display method of claim 10,
wherein the information identification step includes determining a type of road on which the vehicle is driving based on the driving guidance information and the location information of the vehicle, and
wherein the guidance information determination step includes setting the first reference distance based on the identified type of road.

15. The driving information display method of claim 10,
wherein the information identification step includes identifying a level of road congestion on the driving route of the vehicle based on the driving guidance information and the location information of the vehicle, and
wherein the guidance information determination step includes setting the first reference distance based on the identified level of the road congestion.

16. The driving information display method of claim 10, wherein the guidance information determination step includes:
in response that a re-search for a route is performed while the augmented reality-based guidance information is being output,
determining to output the augmented reality-based guidance information until a new guidance point is identified through the re-search for the route.

17. The driving information display method of claim 10,
wherein information related to the guidance point further includes information related to a lane guidance point at which there is provided guidance on a lane along which the vehicle needs to drive before the guidance point, and
wherein the guidance information determination step includes:
in response that a distance between the guidance point and the lane guidance point is equal to or longer than a predetermined third reference distance,
determining the guidance information to be output using a location of the lane guidance point.

18. The driving information display method of claim 17,
wherein the third reference distance is set to a distance which is longer than the first reference distance by a predetermined ratio, and
wherein the guidance information determination step further includes:
in response that a distance between the guidance point and the lane guidance point is equal to or longer than the predetermined third reference distance,
determining the augmented reality-based guidance information to be the guidance information to be output in response that the vehicle has passed through the lane guidance point along the driving route and a distance between the vehicle and the lane guidance point is equal to or longer than a difference between the third reference distance and the first reference distance.
